(19) United States
(12) Patent Application Publication
(10) Pub. No.: US 2005/0033543 A1
(43) Pub. Date: Feb. 10, 2005

(54) System and method for testing of transaction initiation devices in electronic funds transfer systems

(75) Inventor: Carl Kubitz, Scottsdale, AZ (US)

Correspondence Address: DONALD J. LENKSZUS, PO BOX 3064, CAREFREE, AZ, 85377, US

(73) Assignee: LEXCEL SOLUTIONS, INC., Scottsdale, AZ (US)

(21) Appl. No.: 10/635,420

(22) Filed: Aug. 5, 2003

(51) Int. Cl. G06F 19/00

(52) U.S. Cl. 702/120

(57) ABSTRACT

An arrangement is provided for testing of transaction initiation devices of the types used in EFT systems. An interface is provided in each device which is accessible by a personal computer. Test scripts are generated and the computer causes the transaction initiation device to execute each test script automatically.

### FIELD OF THE INVENTION

The invention pertains to Electronic Funds Transfer systems, in general, and to a system and method for the testing of transaction initiation devices, in particular.

### BACKGROUND OF THE INVENTION

Electronic Funds Transfer (EFT) systems that are widely in use typically include numerous transaction initiation devices that are used to initiate EFT exchanges. Typical of transaction initiation devices are automatic teller machines (ATMs), point of sale (Pos) devices, gas pumps, grocery store terminals, wireless data terminals and EFT devices.

Each of these transaction initiation devices typically includes a graphical interface such as a display, a manual input such as a keypad, and a card reader for reading credit/debit cards, memory and a microprocessor. The transaction initiationdevices are made operational by downloads of software that provide specific functionality and features.

To provide superior service levels and to maintain data processing integrity, EFT organizations must plan for and test the complete range of operational extremes. Many times, weaknesses in application software or hardware systems only surface under extreme operating conditions.

Accordingly, it is highly desirable to provide for testing each aspect of an EFT system by testing the ability of each portion of the EFT system to handle volumes of electronic funds transactions representative of expected transactions both in terms of the quantities of such transactions and the various types of such transactions.

One particular problem area is that of testing the operability and functionality of POI devices. In the past, such devices were tested by generating a test plan that would be manually executed. The test plan would include all combinations of inputs, transactions and system responses. Such plans might include tens of thousands of entries and responses. To provide complete verification testing utilizing test plans and manual input can require months of testing. Such test verification must be completed prior to certification of the POI device with software download.

It is therefore highly desirable to provide a system and method for the automatic verification testing of transaction initiation devices.

### SUMMARY OF THE INVENTION

A system in accordance with the invention provides a capability to perform automatic verification tests of transaction initiation devices.

The system in accordance with the invention acts as an accelerator to drive transactions in a rapid-fire progression of scripted messages in specified formats into a transaction initiation device, monitors display messages provided by the transaction initiation device, and access and monitor the transaction initiation device memory.

The system of the invention provides logging and reporting capabilities specifically designed for in-depth post-test analysis. A trace file is created for all transactions and responses for further post-test analysis and review. Test session results are exportable for customer report generation.

A system for testing of an electronic funds transfer (EFT) host system in accordance with the principles of the invention includes a test administration and data generation first processor that is operable to generate predetermined scripts of EFT test messages for the transaction initiation device. The system of the invention further includes a predetermined number of second processors, each coupled to the regular communication port of the transaction initiation device to simulate EFT system responses.

Data collection and processing software is provided at the first processor The first processor is operable to generate a data record of responses of the transaction initiation device.

The test processor has a display operable to provide graphical images of the input and response of the transaction initiation device to test messages.

### BRIEF DESCRIPTION OF THE DRAWING

The invention will be better understood from a reading of the following detailed description of an illustrative embodiment of the invention in conjunction with the drawing figures in which like reference designators are used to identify like elements, and in which:

FIG. 1 is block diagram of a system in to which the principles of the invention may be advantageously applied;

FIG. 2 illustrates a POS device which may incorporate the principles of the invention;

FIG. 3 is a block diagram of the device of FIG. 2;

FIG. 4 is a second block diagram of the device of FIG. 2;

FIG. 5 illustrates a portion of the system of FIG. 1 in a first test configuration;

FIG. 6 illustrates the test procedure in accordance with the invention;

FIG. 7 illustrates operation of the system in accordance with the invention;

FIG. 8 illustrates a portion of the system of FIG. 1 in a second test configuration;

FIG. 9 illustrates the system of the invention utilized for remote testing; and

FIG. 10 illustrates operation of the system configuration of FIG. 8.

### DETAILED DESCRIPTION

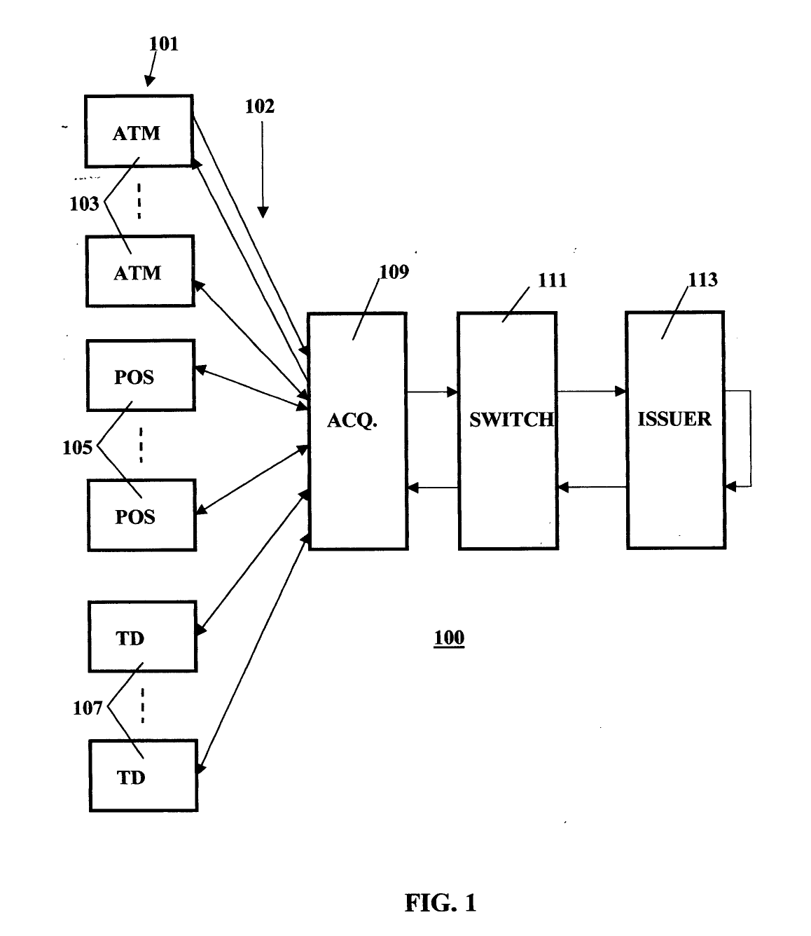

FIG. 1 illustrates an EFT system 100 having a plurality of transaction initiation devices 101 coupled thereto The transaction initiation devices may include ATM's 103, point of sale devices 105 and other transaction devices 107. The transaction initiation devices 101 may be any of the conventionally available transaction devices. For example, the point of sale devices may be POS devices commercially available from Verifone or Hypercom.

Each transaction initiation device 101 is coupled to EFT system 100 via communication links 102. The communication links may be connections over the public switched telephone network, dedicated connections, LAN or WAN or any other communication link that is utilized in an EFT system. The communication links 102 couple transaction devices 101 to an acquisition EFT system 109 which in turn may be coupled to an EFT switch 111 that directs each EFT transaction to an issuer system 113.

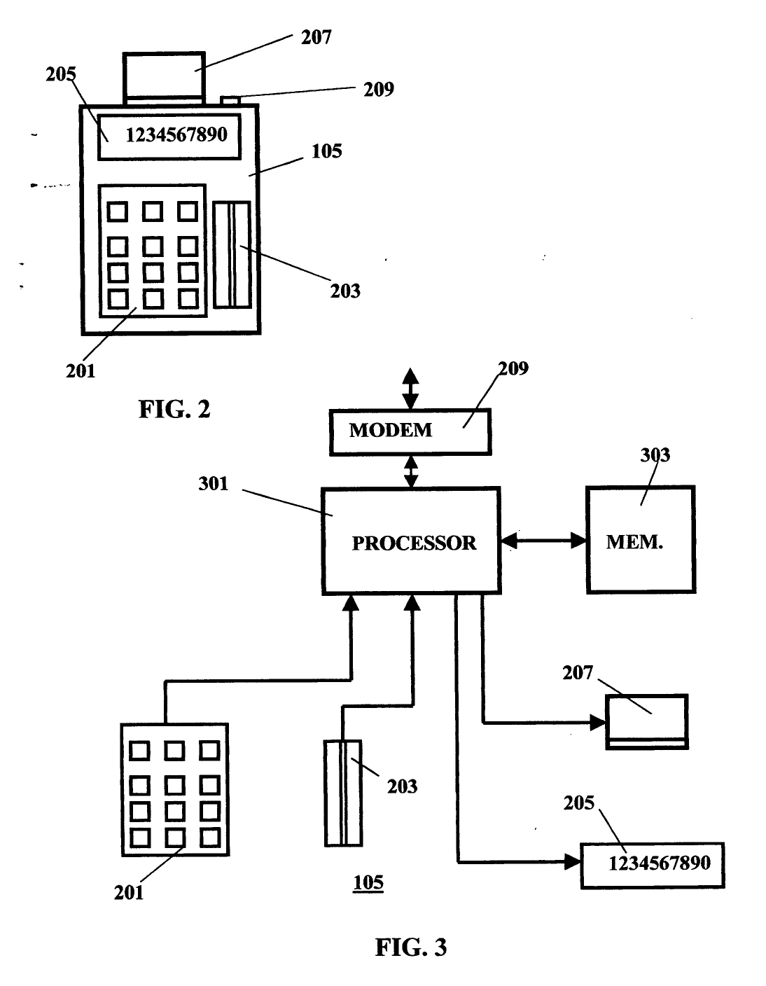

Turning now to FIGS. 2 and 3, a representative POS device 105 is shown. POS device 105 includes input apparatus 201, 203 for inputting an EFT request, and output apparatus 205, 207 for providing indications of input requests and responses from the EFT system 100. In POS device 105, the input apparatus includes a keypad 201 and a card reader 203 which may be a card reader for credit, debit and/or other financial cards. The output apparatus includes a display 205 and a printer 207. Both the display 205 and the printer 207 may also be of any commercially available design. In some POS devices 105 the input and output apparatus may be integrated together in, for example, a touch screen. In accordance with the principles of the invention, the particular type of input apparatus and output apparatus is not of particular significance. The principles of the invention may be applied to a POS device or transaction initiation device having any type of input and output apparatus including input and output apparatus integrated into a single unit or a multifunctional apparatus.

POS device 105 further includes a processor 301, a memory 303 and an I/0 interface 209 which may be a modem, for example, for transmitting transaction requests to EFT system 100 and for receiving responses from EFT system 100. In addition, software downloads are received from EFT system 100 or via other systems connected to modem 209 for programming features and functionality into POS device 105. The software downloads are stored in memory 303. In addition, memory 303 is utilized to store transaction information. Memory 303 and processor 301 may be any commercially available memory and processor, respectively.

In the past, all testing of transaction devices has been done manually with no automation. Specifically a test plan is prepared for each transaction device. The plan typically sets out particular keystroke sequences. An individual enters each sequence, views the display to determine if the keystroke sequence is registered, initiates the EFT transaction and then views and records the displayed result. To completely exercise the functionality of the transaction device, thousands of input combinations and transaction requests must be executed to assure flawless operation of the unit with the EFT system. Typically it takes several months to perform these manual operations.

Further complicating the problem is that up until now each manufacturer has its own proprietary mechanisms for each transaction device.

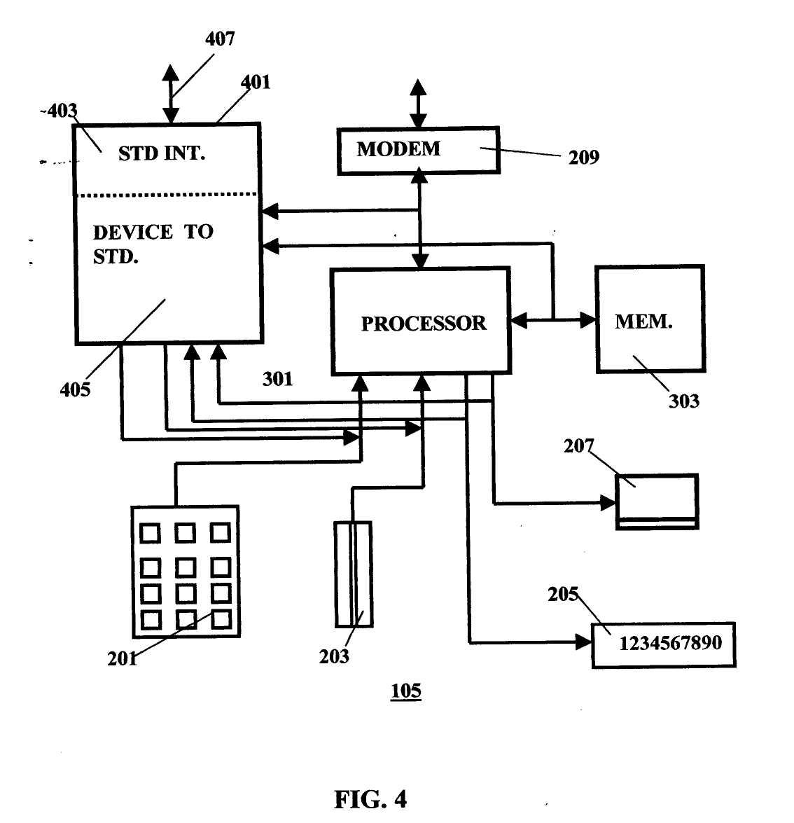

Turning now to FIG. 4, an access port 407 is provided for transaction device 105. Access port 407 is configured to permit automatic operation and reading of transaction device 105 without manual intervention. An interface to POS device 105 is provided that comprises a standard interface portion 403 and a vendor/ device specific interface portion 405. Interface 401 may be implemented as hardware, or as software or as a combination hardware/ software unit.

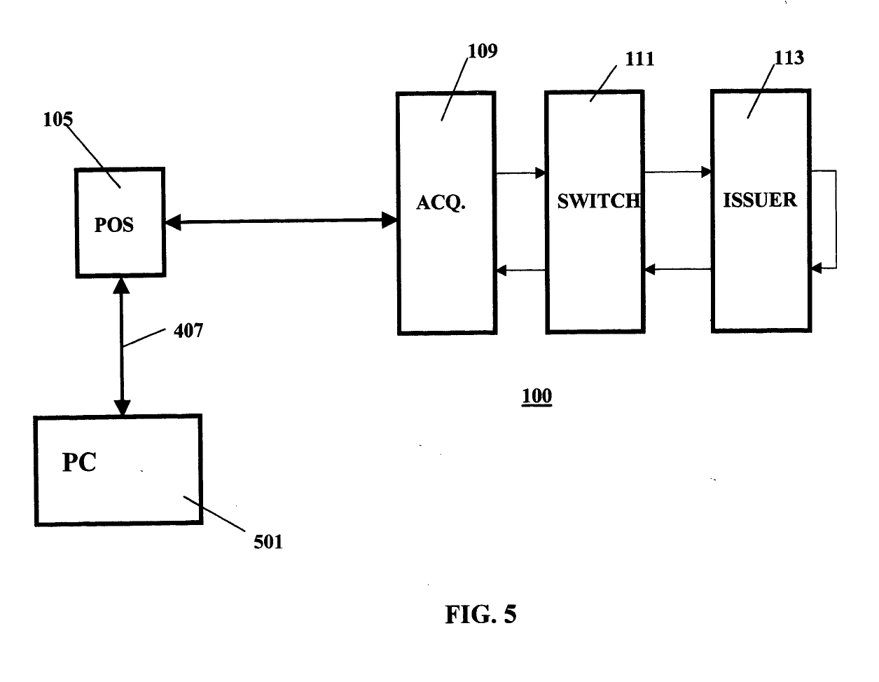

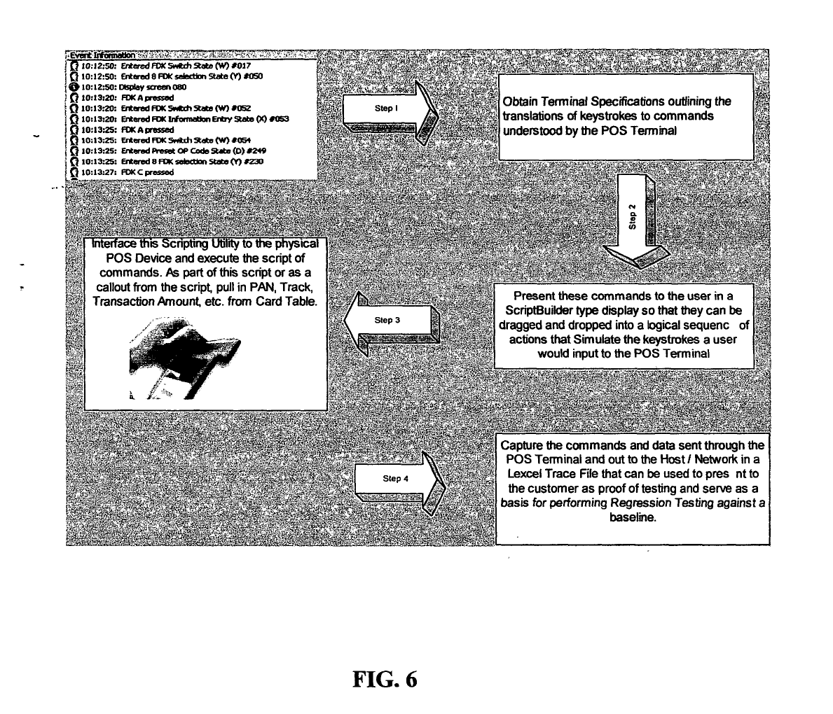

With the configuration of FIG. 4 provided in each transaction initiation device 105, a test processor 501 may be connected to the POS device 105 as shown in FIG. 5.

PC 105 includes a software solution to automate testing of transaction initiation devices. PC 105 is used to generate transaction test scripts for various transaction initiation device models. PC 105 sends the transactions to transaction initiation device, which in turn communicates the transaction to the EFT network 100.

FIG. 6 illustrates in graphical form the steps that are implemented by the system of the invention.

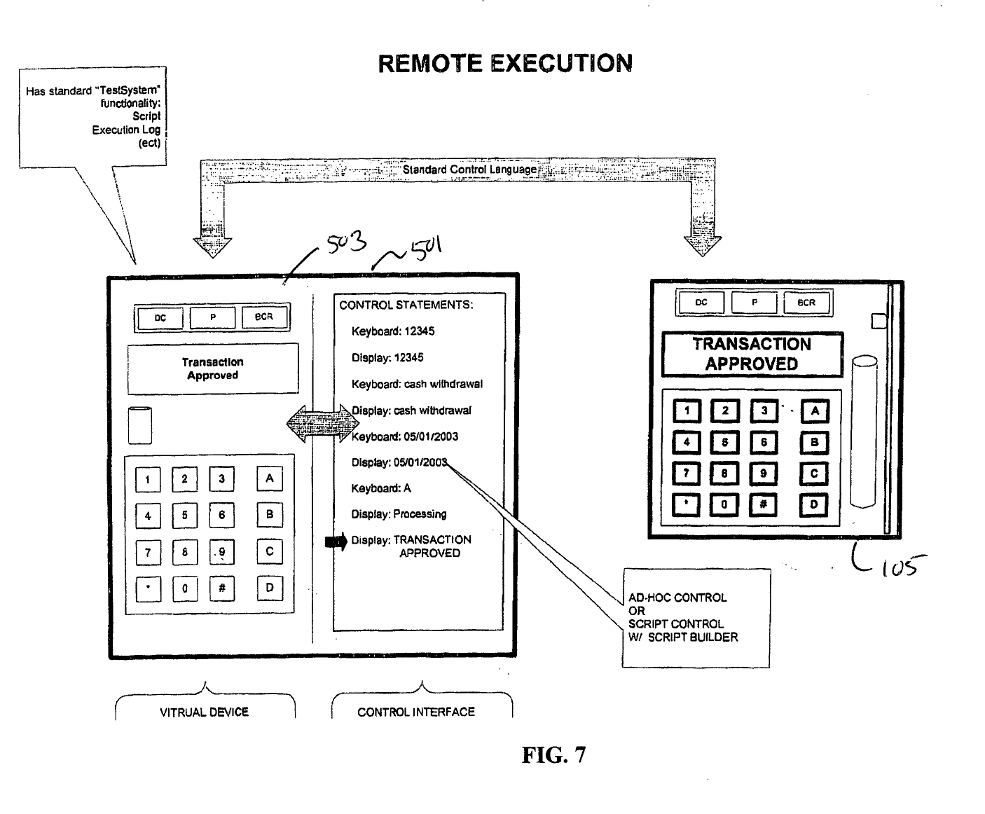

Personal computer 501 includes a display 503 that permits the displaying of an image of device 105 as a virtual device as shown in FIG. 7. In addition, each test is displayed as a control interface.

The test arrangement of the invention encompasses testing activities undertaken by Quality Assurance and Certification groups, as well as opportunity to use the software solution for technical support and troubleshooting test/production issues.

The scripting utility in personal computer 501 is based upon an existing ScriptBuilder™ architecture commercially available from Lexcel Solutions, Inc. Automation is provided for previously manually intensive terminal and transaction testing. The system is usable throughout many organizations in the US and Internationally.

Diagnostic support is achieved from personal computer 501 through a direct protocol interface to the POS device 105. This enables help desk personnel to access the POS device to perform keystrokes, swipe cards, build transactions, send commands, initiate downloads, etc. through the TestSystem™ interface available from Lexcel Solutions, Inc. This approach eliminates the time spent swapping out terminals just to be able to troubleshoot where the problem resides.

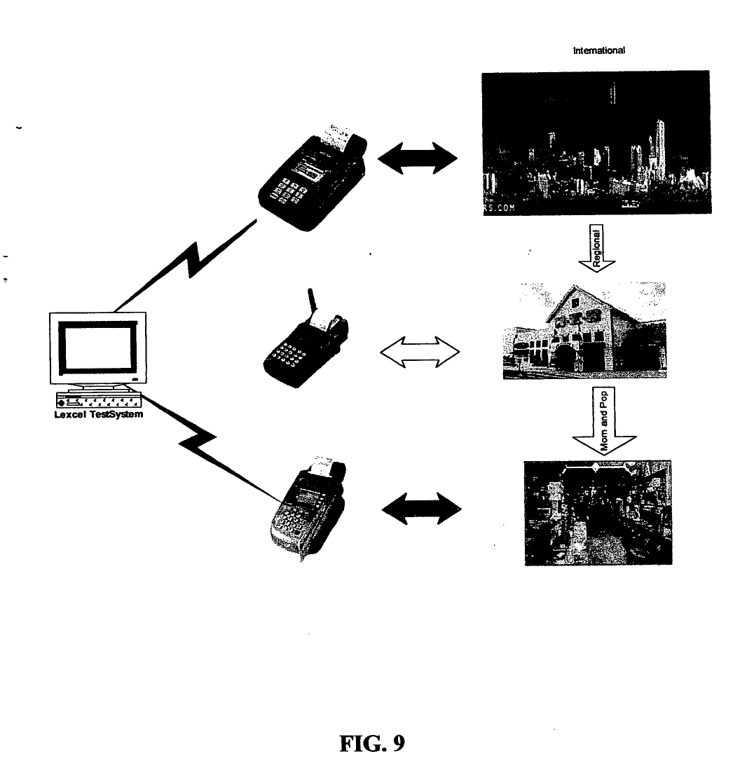

With the system of the invention, the personal computer 501 utilized to test transaction initiation devices 101 may be geographically remote from the devices as illustrated in FIG. 9.

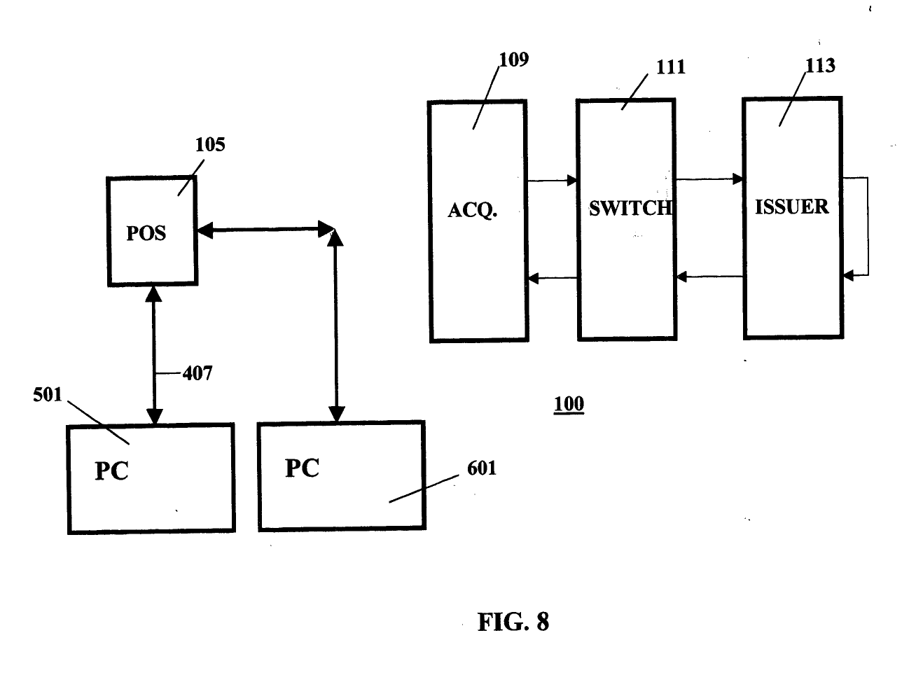

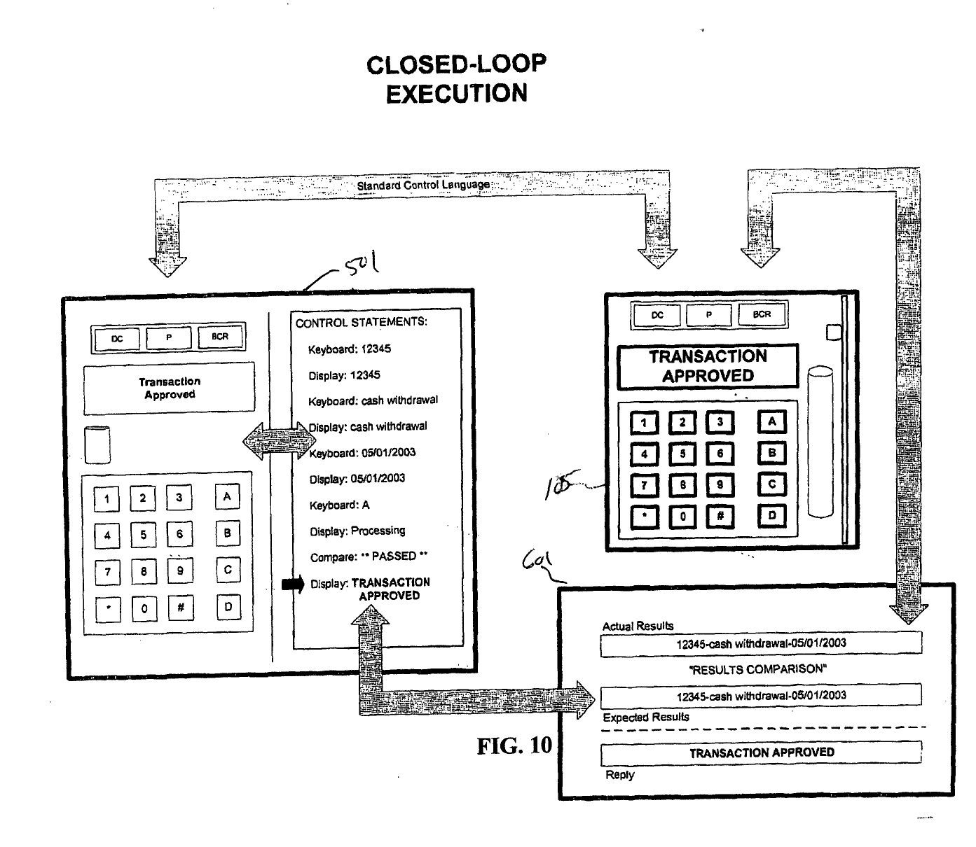

Turning now to FIGS. 8 and 10, by utilizing a second PC 601 as a responder a POS device 105, a closed loop test execution system may be easily provided in which test scripts may be provided for both inputs provided to device 105 by personal computer 501, but in addition scripted responses may be provided from another personal computer 601. In an alternate embodiment of the invention, the same personal computer could provide the functionality of both scripted inputs and scripted responses to device 105.

The invention has been described in terms of various embodiments. It is not intended that the invention be limited to the illustrative embodiments. It will be apparent to those skilled in the art that various modifications and changes may be made to the embodiments without departing from the spirit or scope of the invention. Accordingly, it is intended that the invention be limited only by the claims appended hereto.

1. A test system for testing a transaction initiation device of the type having manually operable inputs, a human readable display for displaying messages, memory and a processor comprising:
an interface for converting proprietary signaling within said transaction intitiation device to a standard interface for use with multiple proprietary arrangements, said interface being coupled to provide substitute input signals in place of signals from said device manually operable inputs; said interface being coupled to inputs to said human readable display; and
a computer program operable to access said interface to provide test scripts to said interface to generate said substitute input signals and to receive said inputs to said human readable display.

2. A test system in accordance with claim 1, further comprising:
a trace file for storing each said test script and corresponding display results

3. A test system in accordance with claim 1, wherein;
said interface is coupleable to said memory; and
said test system comprises a computer program for accessing the contents of said memory for analysis purposes.

4. A system in accordance with claim 1, comprising;
a test computer coupleable to said interface and operable in accordance with said computer program.
